(19) United States
(12) Patent Application Publication
(10) Pub. No.: US 2026/0164519 A1
(43) Pub. Date: Jun. 11, 2026

(54) LIGHTING DEVICE AND CONTROL METHOD THEREFOR

(71) Applicant: SAMSUNG ELECTRONICS CO., LTD, Suwon-si (KR)

(72) Inventors: Eunha CHOI, Suwon-si (KR); Jieun KIM, Suwon-si (KR); Seungjoon LEE, Suwon-si (KR)

(73) Assignee: SAMSUNG ELECTRONICS CO., LTD, Suwon-si (KR)

(21) Appl. No.: 19/179,656

(22) Filed: Apr. 15, 2025

Related U.S. Application Data
(63) Continuation of application No. PCT/KR2023/013834, filed on Sep. 14, 2023.

(30) Foreign Application Priority Data
Oct. 28, 2022 (KR) 10-2022-0141810

(51) Int. Cl. H05B 45/12; F21V 23/04; F21Y 105/16; F21Y 115/10; H05B 47/11; H05B 47/115; H05B 47/16; H05B 47/175; H05B 47/19

(52) U.S. Cl. CPC H05B 45/12; F21V 23/0442; H05B 47/11; H05B 47/115; H05B 47/16; H05B 47/19; H05B 47/1965; F21Y 2105/16; F21Y 2115/10

(57) ABSTRACT

A lighting device includes: a communicator configured to communicate with a user terminal; a light emitter including a plurality of light emitting devices in a two-dimensional (2D) arrangement; at least one memory storing instructions, and a target illuminance of an indoor space corresponding to a lighting direction and a time of the indoor space; and at least one processor operatively connected to the communicator, the light emitter and the at least one memory, where the at least one processor is further configured to execute the instructions to:
determine the lighting direction of the indoor space based on an input from the user terminal, and control the light emitter to illuminate the indoor space to the target illuminance based on the determined lighting direction and the time.

### CROSS-REFERENCE TO RELATED APPLICATIONS

This application is a continuation of International Application No. PCT/KR2023/013834, filed on Sep. 14, 2023, in the Korean Intellectual Property Receiving Office, which is based on and claims priority to Korean Patent Application No. 10-2022-0141810, filed on Oct. 28, 2022, in the Korean Intellectual Property Office, the disclosures of which are incorporated by reference herein in their entireties.

### BACKGROUND

### 1. Field

The disclosure relates to a lighting device that illuminates indoor space and a method of controlling the lighting device.

### 2. Description of Related Art

In general, a lighting device may be a device arranged in an indoor space and capable of illuminating the indoor space, so that the indoor space may have a different atmosphere according to the illumination from the lighting device.

The lighting device may include a light emitting device such as a light emitting diode (LED), and the light emitting device may emit light according to an input of the user.

The light device may be a passive device that operates based on the input of the user (e.g., switching on/off), but technology to automatically control illumination in response to an environmental change in the indoor space is being actively discussed.

### SUMMARY

Provided are a lighting device and method of controlling the same, which may give an impression as if sunlight is coming into an ill-lighted indoor space by implementing a sunlit environment with the lighting device.

Further, provided are a lighting device and method of controlling the same, which may give an impression as if sunlight is coming in from a desired direction by setting a direction of lighting required depending on the living and working condition of the user.

Additional aspects will be set forth in part in the description which follows and, in part, will be apparent from the description, or may be learned by practice of the presented embodiments.

According to an aspect of the disclosure, a lighting device may include: a communicator configured to communicate a user terminal; a light emitter including a plurality of light emitting devices in a two-dimensional (2D) arrangement; at least one memory storing instructions, and a target illuminance of an indoor space corresponding to a lighting direction and a time of the indoor space; and at least one processor operatively connected to the communicator, the light emitter and the at least one memory, where the at least one processor is further configured to execute the instructions to: determine the lighting direction of the indoor space based on an input from the user terminal, and control the light emitter to illuminate the indoor space to the target illuminance based on the determined lighting direction and the time.

The at least one memory may store a target illuminance for each area of the indoor space corresponding to the lighting direction and the time of the indoor space, where the at least one processor is further configured to execute the instructions to control the light emitter to illuminate each area of the indoor space to the target illuminance of each area respectively.

The at least one processor may be further configured to execute the instructions to control the light emitter to illuminate the indoor space with an illuminance having a gradation.

The lighting device may further include an illuminance sensor configured to detect an illuminance of the indoor space, where the at least one processor is further configured to execute the instructions to determine a starting area of the gradation based on a detection by the illuminance sensor.

The at least one processor may be further configured to execute the instructions to determine an area with a greatest change in illuminance as the starting area of the gradation.

The at least one processor may be further configured to execute the instructions to determine a starting area of the gradation based on information input through the user terminal.

The at least one processor may be further configured to execute the instructions to: determine a location of a user in the indoor space, and control the light emitter to illuminate the location of the user.

The at least one processor may be further configured to execute the instructions to determine the location of the user in the indoor space based on an ultra-wide band (UWB) signal received by the communicator.

The at least one processor may be further configured to execute the instructions to: identify a display device in the indoor space, and control the light emitter to illuminate an area other than the display device.

The communicator may be further configured to receive information about a non-illumination area from the user terminal, where the at least one processor is further configured to execute the instructions to control the light emitter to illuminate an area other than the non-illumination area based on the received information.

The target illuminance may correspond to an illuminance of sunlight within the indoor space.

According to an aspect of the disclosure, a method of controlling a lighting device may include: storing a target illuminance of an indoor space corresponding to a lighting direction and a time of the indoor space; determining the lighting direction of the indoor space based on an input from a user terminal; determining the target illuminance of the indoor space based on the determined lighting direction and the time of the indoor space; and controlling a light emitter to illuminate the indoor space to the target illuminance.

The storing the target illuminance may include storing a target illuminance for each area of the indoor space corresponding to the lighting direction and the time of the indoor space, where the controlling the light emitter includes controlling the light emitter to illuminate each area of the indoor space to the target illuminance of each area respectively.

The controlling the light emitter may further include controlling the light emitter to illuminate the indoor space with an illuminance having a gradation.

The method may further include: detecting an illuminance of the indoor space; and determining a starting area for the gradation based on the detecting the illuminance.

The determining of the starting area of the gradation may include determining an area with the largest change in illuminance as the starting area for the gradation.

The method may further include determining a starting area for the gradation based on information input through the user terminal.

The method may further include determining a location of a user in the indoor space, and controlling the light emitter to illuminate the determined location of the user.

The determining of the location of the user in the indoor space may include determining a location of the user in the indoor space based on an ultra wide band (UWB) signal received by a communicator.

The method may further include recognizing a display device in the indoor space; and controlling the light emitter to illuminate an area other than the recognized display device.

The method may further include receiving information about a non-illumination area from the user terminal; and controlling the light emitter to illuminate an area other than the non-illumination area based on the received information.

The target illuminance may be set to have a value equal to illuminance of sunlight brought into the indoor space.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram for describing an example of installation of a lighting device, according to an embodiment;

FIG. 2 is an exterior view of a lighting device, according to an embodiment;

FIG. 3 is a side cross-sectional view of a lighting device, according to an embodiment;

FIG. 4 is a diagram for schematically describing arrangement of light emitting devices of a lighting device, according to an embodiment of the disclosure;

FIG. 5 is a control block diagram of a lighting device, according to an embodiment;

FIG. 6 illustrates differences in illuminance from sunlight incidence depending on time and direction, according to an embodiment;

FIG. 7 illustrates an indoor space illuminated by a lighting device, according to an embodiment;

FIG. 8 illustrates differentiation of an illumination area of a lighting device over time, according to an embodiment;

FIG. 9 illustrates illuminance sensors arranged in a lighting device, according to an embodiment;

FIG. 10 illustrates a screen for setting a starting point of gradation, according to an embodiment;

FIG. 11 illustrates a lighting device illuminating a user, according to an embodiment;

FIG. 12 illustrates setting a non-illumination area of a lighting device, according to an embodiment;

FIG. 13 illustrates recognizing a display device in an indoor space, according to an embodiment; and

FIG. 14 is a flowchart illustrating a method of controlling a lighting device, according to an embodiment.

### DETAILED DESCRIPTION

Embodiments and features as described and illustrated in the disclosure are merely examples, and there may be various modifications replacing the embodiments and drawings at the time of filing this application.

Throughout the drawings, like reference numerals refer to like parts or components.

The terminology used herein is for the purpose of describing particular embodiments only and is not intended to limit the disclosure. It is to be understood that the singular forms “a,” “an,” and “the” include plural references unless the context clearly dictates otherwise. It will be further understood that the terms “include”, “including”, “has”, “having”, “comprise”, “comprising,” and the like, when used in this specification, specify the presence of stated features, integers, steps, operations, elements, and/or components, but do not preclude the presence or addition of one or more other features, integers, steps, operations, elements, components, and/or groups thereof.

Furthermore, throughout the specification, when a component is “connected” or “coupled” to another component, it includes not only a case that the component is directly connected or coupled to the other component but also a case that they are indirectly connected or coupled to each other.

The terms including ordinal numbers like “first” and “second” may be used to explain various components, but the components are not limited by the terms. The terms are only for the purpose of distinguishing a component from another. For example, a first element could be termed a second element and vice versa, without departing from the scope of the disclosure. Descriptions shall be understood as to include any and all combinations of one or more of the associated listed items when the items are described by using the conjunctive term “˜and/or ˜,” or the like.

Reference will now be made to embodiments of the disclosure, which are illustrated in the accompanying drawings.

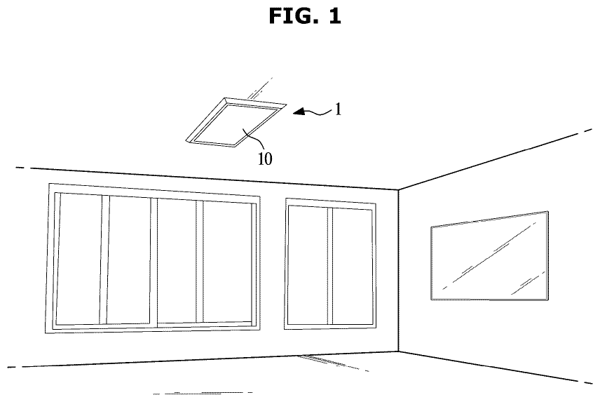

FIG. 1 is a diagram for describing an example of installation of a lighting device, according to an embodiment.

Referring to FIG. 1, a lighting device 1 according to an embodiment may be arranged on the ceiling of an indoor space to illuminate the indoor space.

For example, as shown in FIG. 1, the lighting device 1 may include at least one lighting module 10, and the lighting module 10 may include an array of light emitting devices, as will be described later, to illuminate the indoor space. There is no limitation on the number of lighting modules 10 included in the lighting device 1, and a different number of lighting modules 10 may be provided.

In the disclosure, for convenience of explanation, the lighting module 10 provided in singular will be taken as an example.

In an embodiment, the lighting device 1 may illuminate the indoor space with light of a color and brightness for giving an impression as if sunlight is coming into the indoor space. This will be described in detail later.

Structural characteristics of the lighting device 1 will now be schematically described first.

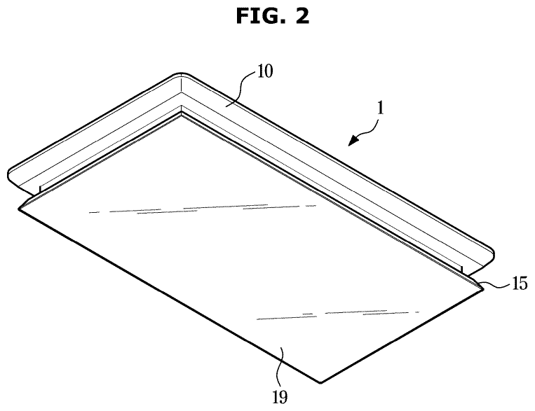

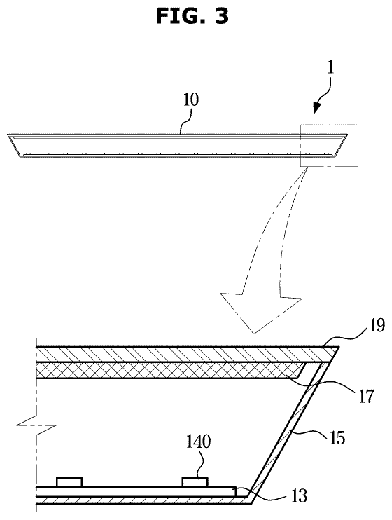

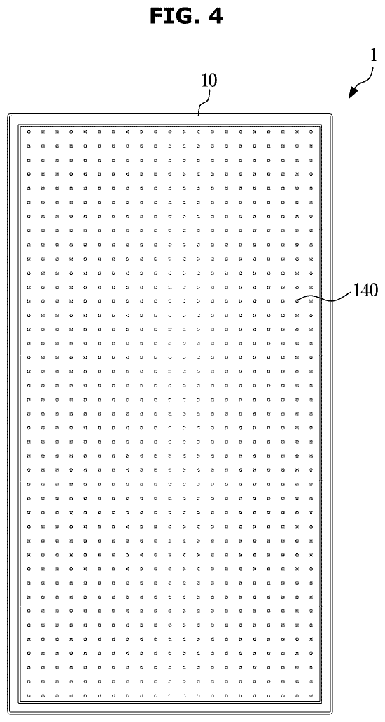

FIG. 2 is an exterior view of the lighting device 1, according to an embodiment, FIG. 3 is a side cross-sectional view of the lighting device 1, according to an embodiment, and FIG. 4 is a diagram for schematically describing arrangement of light emitting devices of the lighting device 1, according to an embodiment of the disclosure.

Referring to FIGS. 2 and 3, the lighting module 10 of the lighting device 1 according to an embodiment may include an illuminating window 19 arranged on the ceiling and on the lower surface of a body 15 to illuminate downward.

For example, the illuminating window 19 may be a flat plate formed of a transparent material, which may be a polymethyl methacrylate (PMMA) material. However, the illuminating window 19 may be formed of any material that is transparent.

The body 15 of the lighting module 10 may fasten the lighting module 10 to the ceiling, and may fix a printed circuit board 13 with a light emitting device 140 arranged thereon, a diffuser plate 17 that diffuses light emitted from the light emitting device 140 and the illuminating window 19 that illuminates the indoor space.

The printed circuit board 13 having an array of the light emitting devices 140 may be arranged in the body 15, and the diffuser plate 17 and the illuminating window 19 may be arranged in front of the printed circuit board 13.

The light emitting devices 140 may be provided on the upper surface of the printed circuit board 13 in a two-dimension (2D) as shown in FIG. 4, and may have a driving voltage and a driving current applied thereto by a power line and a driving device arranged on the printed circuit board 13.

For example, the light emitting devices 140 may be provided as light emitting diodes (LEDs) or organic LEDs (OLEDs). The LEDs may be implemented in various sizes, including, e.g., mini LEDs and/or micro LEDs.

Rays emitted from the light emitting devices 140 may be first incident on the diffuser plate 17, diffused, incident on the illuminating window 19, and thus emitted to the indoor space.

In this case, to avoid non-uniformity in brightness caused by the plurality of light emitting devices 140, the diffuser plate 17 may diffuse the rays emitted from the plurality of light emitting devices 140 within the diffuser plate 17. In other words, the diffuser plate 17 may uniformly emit non-uniform rays forward from the plurality of light emitting devices 140.

Structural characteristics of the lighting device 1 have been schematically described above. Operations of the lighting device to give an impression as if sunlight is brought indoors will now be described in detail.

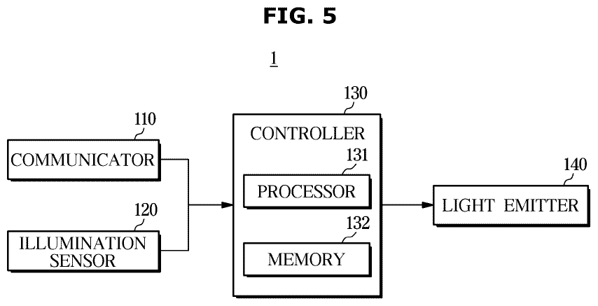

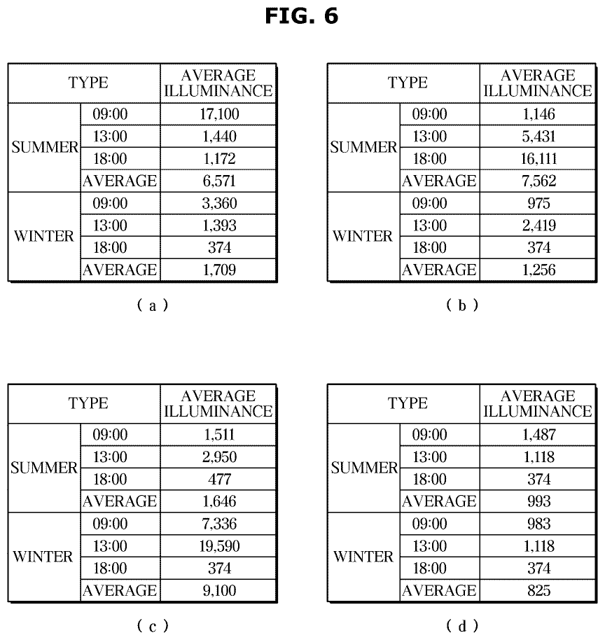

FIG. 5 is a control block diagram of a lighting device, according to an embodiment, and FIG. 6 illustrates differences in illuminance from sunlight incidence depending on time and direction, according to an embodiment.

Referring to FIG. 5, the lighting device 1 according to an embodiment may include a communicator 110 for performing communication with a terminal of a user U, an illuminance sensor 120 for detecting illuminance of indoor space R, a light emitter 140 including a plurality of light emitting devices arranged in 2D and a controller 130. The controller 130 may include a memory 132 for storing target illuminance of the indoor space R depending on lighting direction and time of the indoor space R, and at least one processor 131 for controlling the communicator 110, the light emitter 140 and the memory 132.

The configuration of the lighting device 1 shown in FIG. 5 is, however, merely an example, and some of the components included in FIG. 5 may be omitted or a component not included in FIG. 5 may be added to the configuration of the lighting device 1 in another embodiment.

In an embodiment, the communicator 110 may perform communication with the terminal of the user U located in the indoor space R where the lighting device 1 is arranged. For this, the communicator 110 may be provided as a known-type of radio communication module.

The communicator 110 may also perform communication with an external server in addition to the terminal of the user U.

The memory 132 may store target illuminance of the indoor space R depending on lighting direction and time of the indoor space R. The target illuminance may be set to have a value equal to illuminance of sunlight brought into the indoor space R.

Referring to FIG. 6, (a) shows average illuminance depending on the time and season when sunlight is brought in from the east, (b) shows average illuminance depending on the time and season when sunlight is brought in from the west, (c) shows average illuminance depending on the time and season when sunlight is brought in from the south, and (d) shows average illuminance depending on the time and season when sunlight is brought in from the north.

To give the user U an impression as if sunlight is coming into the indoor space R, the memory 132 may store the illuminance of when actual sunlight is brought in as target illuminance.

For example, to give the user U an impression as if sunlight is brought in from the south, the target illuminance may be set based on the average illuminance shown in (c).

The at least one processor 131 may determine the target illuminance of the indoor space R among the target illuminance stored in the memory 132 based on information received through the communicator 110 and a result of detecting of the illuminance sensor 120.

Specifically, the user U may input a lighting direction through the terminal of the user U. The lighting direction may refer to a direction corresponding to a direction of a window installed at the building, and for example, when the lighting direction is set to the south, an impression as if sunlight is coming in through a window installed to face south may be created.

The communicator 110 may receive information about the lighting direction input to the terminal of the user U.

The lighting device 1 may further include a clock to store time.

The clock may receive, from a server, and store information about the current time, or may receive, from the terminal of the user U, and store information about time input by the user U.

The at least one processor 131 may determine target illuminance based on the lighting direction input to the terminal of the user U and the time stored in the clock.

The at least one processor 131 may control the light emitter 140 for the illuminance of the indoor space R to be the determined target illuminance.

For example, when the user U sets the lighting direction to the south and the time stored in the clock is the current time (e.g., 1 pm on a summer day), the at least one processor 131 may determine the target illuminance to be 2,950 lx and control the light emitter 140 for the illuminance of the indoor space R to be 2,950 lx. The illuminance of the indoor space R may be obtained based on a result of detecting of the illuminance sensor 120 and compared with the target illuminance, and when the illuminance of the indoor space R is lower than the target illuminance, the light emitter 140 may be controlled to increase the illuminance of the indoor space R.

To create an impression that sunlight is coming into the indoor space R, there is a need to differentiate illuminance for each area depending on the inflow direction and intensity of the sunlight. This will now be described.

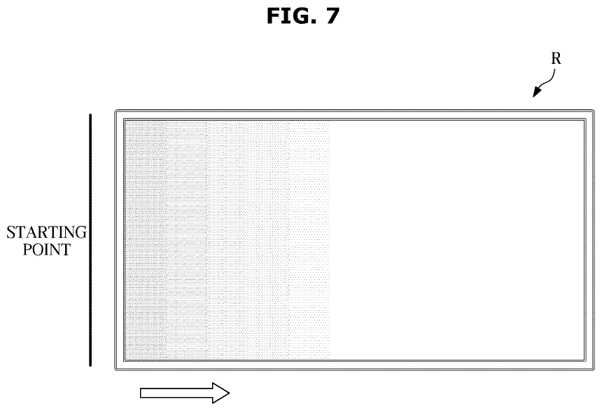

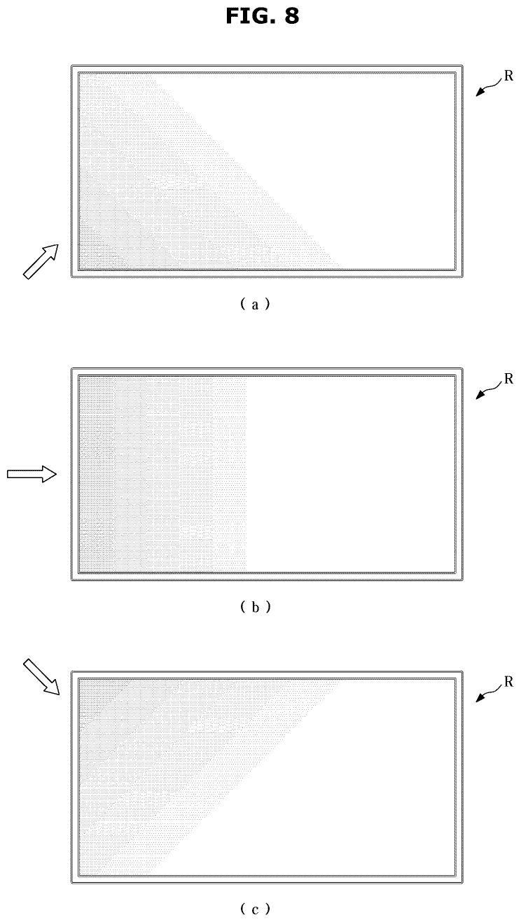

FIG. 7 illustrates an indoor space illuminated by a lighting device, according to an embodiment, and FIG. 8 illustrates differentiation of an illumination area of a lighting device over time, according to an embodiment.

The memory 132 may store target illuminance for each area of the indoor space R depending on time and lighting direction in the indoor space R, and the at least one processor 131 may control the light emitter 140 for the illuminance for each area of the indoor space R to be the target illuminance for the area.

Referring to FIG. 7, it is seen that each area is illuminated at different illuminance to represent that sunlight comes in from the left of the indoor space R.

As such, by illuminating each area at different illuminance, illuminance of the indoor space R may have gradation. How to set a starting point of the gradation will now be described. FIGS. 7 and 8 illustrate an occasion when the left side of the indoor space R is set to the starting point of gradation.

When the user U sets the lighting direction to the south, operation of the lighting device 1 over time is described with reference to FIG. 8. (A) shows illumination at sunrise time, (b) shows illumination at day time, and (c) shows illumination at sunset time.

As the sun rises in the east, passes through the south and sets in the west, sunlight comes from the east at sunrise time in a case of southern exposure. To simulate this, the light emitter 140 may be controlled so that the gradation starts from the bottom left and spreads to the top right, as shown in (a) of FIG. 8.

As in (b) of FIG. 8, the light emitter 140 may also be controlled so that the gradation starts from the left and spreads to the right during the daytime.

Moreover, in the case of southern exposure, sunlight may come in from the west during the sunset hours. To simulate this, the light emitter 140 may be controlled so that the gradation starts from the top left and spreads to the bottom right, as shown in (c) of FIG. 8.

In this way, as target illuminance for each area may be set to change the direction of gradation over time and the light emitter 140 is controlled for the illuminance of the indoor space R to follow the target illuminance, an effect like actual sunlight coming in through the window may be obtained.

A procedure for determining a starting area of the gradation will now be described. The starting area of the gradation may refer to a plane from which the gradation begins among a plurality of planes of the indoor space R. In other words, it may refer to a plane corresponding to the location of the window through which actual sunlight comes in.

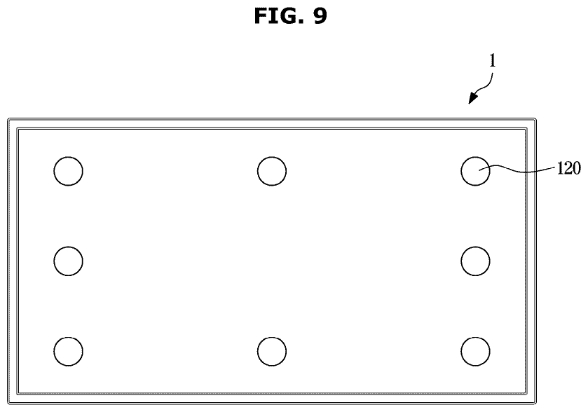

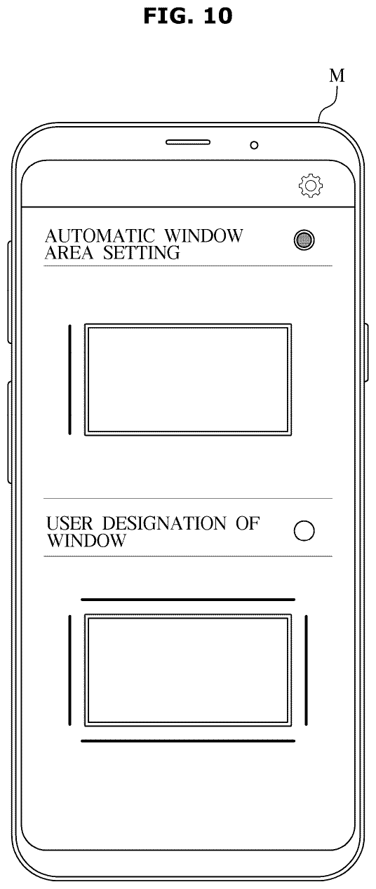

FIG. 9 illustrates illuminance sensors arranged in a lighting device, according to an embodiment, and FIG. 10 illustrates a screen for setting a starting point of gradation, according to an embodiment.

The illuminance sensors 120 may be arranged near edges of the lighting device 1 as shown in FIG. 9. In another embodiment, they may not be arranged directly in the lighting device 1 but may be arranged in an arbitrary area on the ceiling of the indoor space R where the lighting device 1 is installed.

Referring to FIG. 10, the user U may select automatic setting of a starting point of gradation or the user U may directly designate the starting point.

In the case of selecting automatic setting, the at least one processor 131 may determine a starting area of gradation based on a result of detecting of the illuminance sensors 120.

Specifically, the illuminance sensors 120 may obtain changes in illuminance of the plurality of planes of the indoor space R, and determine a plane with the largest change in illumination among the plurality of planes as the starting area of gradation.

As an area where a window is located in the indoor space R has the largest change in illuminance, the plane with the largest change in illuminance may be determined as the starting area of gradation to create an impression as if sunlight is coming in through the window.

In the case that the user U directly sets the starting area of gradation, when the user U designates a desired plane among the plurality of planes of the indoor space R as shown in FIG. 10, the at least one processor 131 may control the light emitter 140 so that gradation begins from the corresponding area.

In this way, by determining the starting area of gradation, an effect like determining the location of a window in the indoor space R may be obtained.

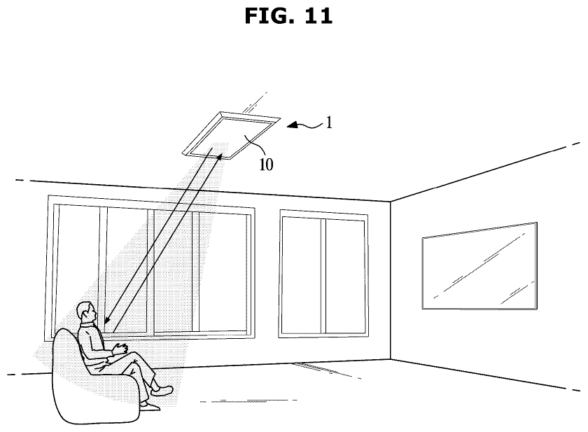

FIG. 11 illustrates a lighting device illuminating a user, according to an embodiment.

As the user U may want to be directly exposed to sunlight coming into the indoor space R which is ill-lighted, the lighting device 1 may control direct illumination to the user U.

Specifically, at least one processor 131 may determine the location of the user U in the indoor space R, and control the light emitter 140 to illuminate the determined location of the user U.

An ultra-wide band (UWB) signal is transmitted from the communicator 110 and a biometric signal of the user U may be received. The at least one processor 131 may determine the location of the user U in the indoor space R based on the UWR signal received by the communicator 110.

The at least one processor 131 may control the light emitter 140 to illuminate the determined location of the user U, thereby obtaining an effect like the user U directly receiving sunlight.

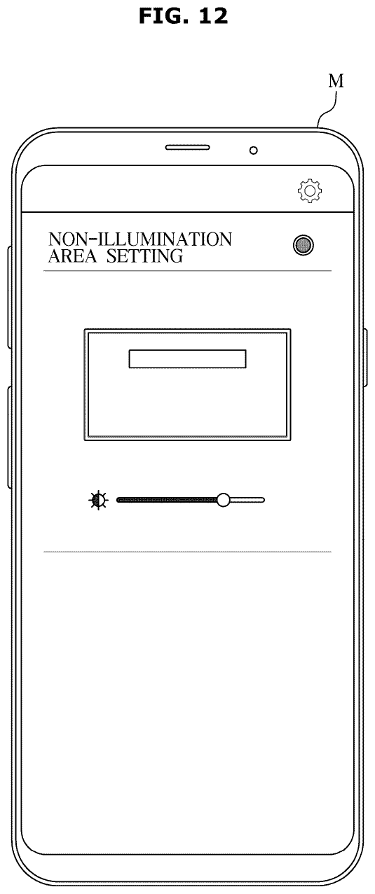

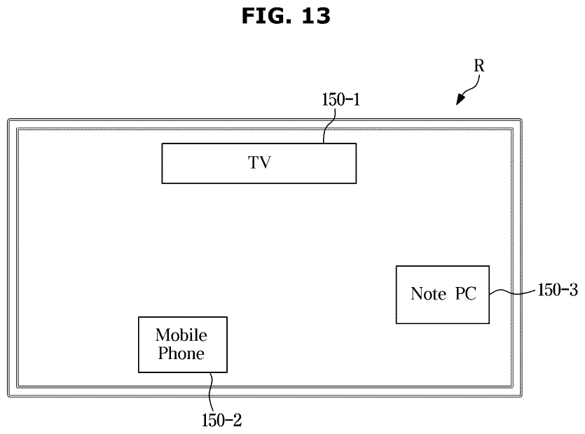

FIG. 12 illustrates setting a non-illumination area of a lighting device, according to an embodiment, and FIG. 13 illustrates recognizing a display device in an indoor space, according to an embodiment.

In a case that the display device 150 such as a TV is used in the indoor space R, when the lighting device 1 illuminates the display device 150, reflecting light may cause inconvenience in watching the display device 150.

Hence, the at least one processor 131 may determine a non-illumination area and control the light emitter 140 to illuminate other areas than the non-illumination area.

Referring to FIG. 12, the user U may set the non-illumination area through the terminal of the user U.

As there may be an area that the user U does not want to illuminate in addition to the display device 150, the user U may be allowed to input a non-illumination area through the terminal of the user U so that other area than the non-illumination area may be illuminated.

Referring to FIG. 13, the display device 150 such as a TV 150-1, a mobile phone 150-2, a PC 150-3, etc., may be located in the indoor space R.

The at least one processor 131 may recognize the display device 150 in the indoor space R and control the light emitter 140 to illuminate other area than the recognized display device 150.

This may avoid inconvenience caused by reflecting rays from illumination of the lighting device 1 in watching the display device 150.

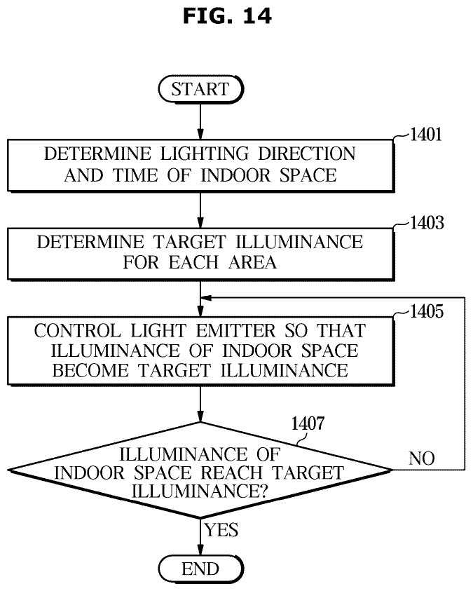

FIG. 14 is a flowchart illustrating a method of controlling a lighting device, according to an embodiment.

The user U may input a lighting direction through the terminal of the user U. The lighting direction may refer to a direction corresponding to a direction of a window installed at the building, and for example, when the lighting direction is set to the south, an impression as if sunlight is coming in through a window installed to face south may be created.

The clock may receive, from a server, and store information about the current time, or may receive, from the terminal of the user U, and store information about time input by the user U.

The at least one processor 131 may determine a lighting direction and time based on information input to the terminal of the user U and the time stored in the clock, in 1401.

The memory 132 may store target illuminance of the indoor space R depending on lighting direction and time of the indoor space R. The target illuminance may be set to have a value equal to illuminance of sunlight brought into the indoor space R.

The at least one processor 131 may determine target illuminance based on the lighting direction input to the terminal of the user U and the time stored in the clock, in 1403.

For example, referring to FIG. 6, when the user U sets the lighting direction to the south and the time stored in the clock is the current time (e.g., 1 pm on a summer day), the at least one processor 131 may determine the target illuminance to be 2,950 lx.

The at least one processor 131 may control the light emitter 140 for the illuminance of the indoor space R to be the target illuminance.

The illuminance of the indoor space R may be obtained based on a result of detecting of the illuminance sensor 120 and compared with the target illuminance, and when the illuminance of the indoor space R is lower than the target illuminance in 1407, the light emitter 140 may be controlled to increase the illuminance of the indoor space R.

According to the disclosure, implementing a sunlit environment with a lighting device may give an impression as if sunlight is coming into an ill-lighted indoor space.

Furthermore, setting a direction of lighting required depending on the living and working condition of the user may give an impression as if sunlight is coming from a desired direction.

Meanwhile, the embodiments of the disclosure may be implemented in the form of a recording medium for storing instructions to be carried out by a computer. The instructions may be stored in the form of program codes, and when executed by a processor, may generate program modules to perform operations in the embodiments of the disclosure. The recording media may correspond to computer-readable recording media.

The computer-readable recording medium includes any type of recording medium having data stored thereon that may be thereafter read by a computer. For example, it may be a read only memory (ROM), a random-access memory (RAM), a magnetic tape, a magnetic disk, a flash memory, an optical data storage device, etc.

According to various embodiments of the disclosure, implementing a sunlit environment with a lighting device may give an impression as if sunlight is coming into an ill-lighted indoor space.

Furthermore, setting a direction of lighting required depending on the living and working condition of the user may give an impression as if sunlight is coming from a desired direction.

The embodiments of the disclosure have thus far been described with reference to accompanying drawings. It will be obvious to those of ordinary skill in the art that the disclosure may be practiced in other forms than the embodiments of the disclosure as described above without changing the technical idea or essential features of the disclosure. The above embodiments of the disclosure are only by way of example, and should not be construed in a limited sense.

What is claimed is:

1. A lighting device comprising:
a communicator configured to communicate with a user terminal;
a light emitter comprising a plurality of light emitting devices in a two-dimensional (2D) arrangement;
at least one memory storing instructions, and a target illuminance of an indoor space corresponding to a lighting direction and a time of the indoor space; and
at least one processor operatively connected to the communicator, the light emitter and the at least one memory,
wherein the at least one processor is further configured to execute the instructions to:
determine the lighting direction of the indoor space based on an input from the user terminal, and
control the light emitter to illuminate the indoor space to the target illuminance based on the determined lighting direction and the time.

2. The lighting device of claim 1, wherein the at least one memory is storing a target illuminance for each area of the indoor space corresponding to the lighting direction and the time of the indoor space, and
wherein the at least one processor is further configured to execute the instructions to control the light emitter to illuminate each area of the indoor space to the target illuminance of each area respectively.

3. The lighting device of claim 2, wherein the at least one processor is further configured to execute the instructions to control the light emitter to illuminate the indoor space with an illuminance having a gradation.

4. The lighting device of claim 3, further comprising an illuminance sensor configured to detect an illuminance of the indoor space,
wherein the at least one processor is further configured to execute the instructions to determine a starting area of the gradation based on a detection by the illuminance sensor.

5. The lighting device of claim 4, wherein the at least one processor is further configured to execute the instructions to determine an area with a greatest change in illuminance as the starting area of the gradation.

6. The lighting device of claim 3, wherein the at least one processor is further configured to execute the instructions to determine a starting area of the gradation based on information input through the user terminal.

7. The lighting device of claim 1, wherein the at least one processor is further configured to execute the instructions to:
determine a location of a user in the indoor space, and
control the light emitter to illuminate the location of the user.

8. The lighting device of claim 7, wherein the at least one processor is further configured to execute the instructions to determine the location of the user in the indoor space based on an ultra-wide band (UWB) signal received by the communicator.

9. The lighting device of claim 1, wherein the at least one processor is further configured to execute the instructions to:
identify a display device in the indoor space, and
control the light emitter to illuminate an area other than the display device.

10. The lighting device of claim 1, wherein the communicator is further configured to receive information about a non-illumination area from the user terminal, and
wherein the at least one processor is further configured to execute the instructions to control the light emitter to illuminate an area other than the non-illumination area based on the received information.

11. The lighting device of claim 1, wherein the target illuminance corresponds to an illuminance of sunlight within the indoor space.

12. A method of controlling a lighting device, the method comprising:
storing a target illuminance of an indoor space corresponding to a lighting direction and a time of the indoor space;
determining the lighting direction of the indoor space based on an input from a user terminal;
determining the target illuminance of the indoor space based on the determined lighting direction and the time of the indoor space; and
controlling a light emitter to illuminate the indoor space to the target illuminance.

13. The method of claim 12, wherein the storing the target illuminance comprises storing a target illuminance for each area of the indoor space corresponding to the lighting direction and the time of the indoor space, and
wherein the controlling the light emitter comprises controlling the light emitter to illuminate each area of the indoor space to the target illuminance of each area respectively.

14. The method of claim 13, wherein the controlling the light emitter further comprises controlling the light emitter to illuminate the indoor space with an illuminance having a gradation.

15. The method of claim 14, further comprising:
detecting an illuminance of the indoor space; and
determining a starting area for the gradation based on the detecting the illuminance.
